(19) United States
(12) Patent Application Publication
(10) Pub. No.: US 2024/0089649 A1
(43) Pub. Date: Mar. 14, 2024

(54) AN EARPHONE AND A METHOD OF PERFORMING A COMMAND BY AN EARPHONE

(71) Applicant: GN Audio A/S, Ballerup (DK)

(72) Inventor: Peter Bach, Ballerup (DK)

(21) Appl. No.: 18/465,539

(22) Filed: Sep. 12, 2023

(30) Foreign Application Priority Data
Sep. 13, 2022 (EP) 22195287.2

(51) Int. Cl. H04R 1/10

(52) U.S. Cl. CPC H04R 1/1041; H04R 1/1016; H04R 2420/07

(57) ABSTRACT

Disclosed is an earphone. The earphone comprises an earphone housing. The earphone further comprises an activation sensor. The activation sensor is configured to sense an activation input from the user and provide an activation signal. The earphone further comprises an adjustment sensor. The adjustment sensor is configured to sense an adjustment input from the user and provide an adjustment signal. The adjustment input is a movement of the earphone housing. The earphone further comprises a processing unit. The processing unit is configured to receive the adjustment signal and execute a command if the adjustment signal is received simultaneously with provision of the activation signal.

### FIELD

The present invention relates to an earphone. More specifically, the disclosure relates to an earphone configured to receive a command from a user and execute said command. In addition, the present invention relates to a method of performing a command by an earphone.

### BACKGROUND

Earbuds have developed significantly over the past years. Some earbuds comprise a button or a sensor. A user of such earbud may provide an instruction to the earbud via the button or the sensor. For instance, the user may tap the earbud at the sensor to accept a call or to reject a call. However, there is still a need for an improved earbud as well as an improved method of performing an instruction by such earbud.

### SUMMARY

According to a first aspect, disclosed is an earphone. The earphone comprises an earphone housing. The earphone further comprises an activation sensor configured to sense an activation input from a user and provide an activation signal. The earphone further comprises an adjustment sensor configured to sense an adjustment input from the user and provide an adjustment signal. The adjustment input is a movement of the earphone housing. The earphone further comprises a processing unit configured to receive the adjustment signal and execute a command if the adjustment signal is received simultaneously with provision of the activation signal.

The earphone may be configured to be worn by the user. The earphone may be configured to be worn at an ear of the user. The earphone may be configured to be worn in, on or over an ear of the user. The user may wear one earphone at one of her/his ears. The user may wear two earphones, one at one of her/his ears and another one at another one of her/his ears. The earphone may be any types of earphones. The earphone may be a headset, a headphone, an earbud, a hearing aid, or another head-wearable hearing device.

The activation sensor is configured to sense and receive the activation input from the user. Thereby, the activation input, provided by the user, activates the activation sensor.

The activation sensor may be a force sensor. The activation sensor may be any of or any combination of the following types of the force sensing technologies. The activation sensor may be a resistive type sensor comprising a mechanical button, a force-resistive resistive, a force-resistive micro-electromechanical systems (MEMS), a force-resistive micro strain gauge. The activation sensor may be a capacitive type sensor such as a capacitive touch or a capacitive force sensor. The activation sensor may be an inductive type sensor such as an inductive force sensor. The activation sensor may be a voltage type sensor such as a piezoelectric force sensor. The activation sensor may be a motion type sensor such as an accelerometer, a gyroscope or an Inertial Measurement Unit (IMU). The activation sensor may be a magnetic type sensor such as a Hall sensor or an IMU (9-axes). The activation sensor may be an optical type sensor such as an IR-sensor or an optic-coupler. The activation sensor may be a sonic type sensor. The activation sensor may be a current type sensor. The activation sensor may be an iontronic type sensor. The activation sensor may be any other types of sensor.

The activation sensor may comprise a button or switch. The activation sensor may comprise a small handle. The activation sensor may comprise a small protrusion. The activation sensor may comprise a surface roughness. The activation sensor may comprise an indentation. The activation sensor may be arranged anywhere at the earphone, accessible by the user when the user is wearing the earphone at its intended position. For example, the activation sensor may be arranged at an out-facing surface of the earphone. Another example, the activation sensor may be arranged at a top side of the earphone i.e. close to a pinna of the user's ear, when the user is wearing the earphone at its intended position. Yet another example, the activation sensor may be arranged at a bottom side of the earphone i.e. close to a lobule of the user's ear, when the user is wearing the earphone at its intended position. Yet another example, the activation sensor may be arranged at a side of the earphone e.g. a left side or a right side of the earphone, when the user is wearing the earphone at its intended position.

The user may provide the activation input to the activation sensor by applying a force to the earphone at the activation sensor. For instance, the user may apply a force to the earphone at the activation sensor using one finger. The user may provide the activation input to the activation sensor by applying a pressure to the earphone at the activation sensor i.e. by pressing the earphone at the activation sensor. For instance, the user may apply a pressure to the earphone at the activation sensor using one finger. The user may provide the activation input to the activation sensor by holding the earphone at the activation sensor. For instance, the user may hold the earphone by a thumb and an index finger wherein one of the thumb or the index finger may be arranged at the activation sensor. The activation sensor is configured to provide the activation signal. The activation sensor may be configured to provide the activation signal to the processing unit.

The activation sensor may be configured to sense the activation input from the user and provide the activation signal while the earphone is ON i.e. after the earphone is turned on and while the earphone is at ON state. The activation sensor may be configured to provide the activation signal while the user provides the activation input to the activation sensor. The activation signal may only be present while the user provides the activation input to the activation sensor. In other words, the activation signal may stop when the user stops providing the activation input to the activation sensor. For instance, if the activation sensor is a force sensor, the activation signal may only be present while the user applies a force to the earphone at the activation sensor. In other words, the activation signal may stop when the user stops applying a force to the earphone at the activation sensor.

The adjustment sensor is configured to sense and receive the adjustment input from the user. The adjustment input is a movement of the earphone housing. Thereby, the adjustment input, provided by the user, activates the adjustment sensor. It is an advantage that the adjustment input is a movement of the earphone housing, as the user provides the adjustment input in a simple, convenient and user-friendly manner. The adjustment sensor may comprise a force sensor. The adjustment sensor may be any of or any combination of the following types of the force sensors. The adjustment sensor may be a resistive type sensor comprising a mechanical button, a force-resistive resistive, a force-resistive micro-electromechanical systems (MEMS), or a force-resistive micro strain gauge. The adjustment sensor may be a capacitive type sensor such as a capacitive touch or a capacitive force sensor. The adjustment sensor may be an inductive type sensor such as an inductive force sensor. The adjustment sensor may be a voltage type sensor such as a piezoelectric force sensor. The adjustment sensor may be a motion type sensor such as an accelerometer, a gyroscope or an Inertial Measurement Unit (IMU). The adjustment sensor may be a magnetic type sensor such as a Hall sensor or an IMU (9-axes). The adjustment sensor may be an optical type sensor such as an IR-sensor or an optic-coupler. The adjustment sensor may be a sonic type sensor. The adjustment sensor may be a current type sensor. The adjustment sensor may be an iontronic type sensor. The adjustment sensor may be a pressure sensor. In the case that the adjustment sensor is a pressure sensor, the adjustment input may be provided by pushing the earphone forward or backward. For instance, pushing the pressure sensor of the earphone forward may increase a pressure output. Another example, pushing the pressure sensor on the earphone backward may decrease a pressure output. The adjustment sensor may be a rotation sensor such as an accelerometer, a gyroscope or an IMU. The adjustment sensor may be any other types of sensors.

The adjustment sensor may comprise a button. The adjustment sensor may comprise a small handle. The adjustment sensor may comprise a small protrusion. The adjustment sensor may comprise a surface roughness. The adjustment sensor may comprise an indentation. The adjustment sensor may be arranged anywhere at the earphone, accessible by the user when the user is wearing the earphone at its intended position. For example, the adjustment sensor may be arranged at a top side of the earphone i.e. close to a pinna of the user's ear, when the user is wearing the earphone at its intended position. Another example, the adjustment sensor may be arranged at a bottom side of the earphone i.e. close to a lobule of the user's ear, when the user is wearing the earphone at its intended position. Yet another example, the adjustment sensor may be arranged at a side of the earphone e.g. a left side or a right side of the earphone, when the user is wearing the earphone at its intended position. The adjustment sensor may be arranged inside the earphone e.g. when the adjustment sensor is a rotation sensor.

The adjustment sensor may comprise one adjustment sensor. The adjustment sensor may comprise a plurality of the adjustment sensors. The plurality of the adjustment sensors may allow for detection of the movement of the earphone housing in a more accurate manner. This is since each of the plurality of the adjustment sensors may detect the movement of the earphone housing at a different position. For instance, in case the adjustment sensor is a pressure sensor, when the user presses the earphone upwards the uppermost sensor may sense a larger force than the lowermost sensor. The plurality of the adjustment sensors may comprise two adjustment sensors. The plurality of the adjustment sensors may be arranged next to each other. For example, the earphone may comprise two adjustment sensors arranged next to each other at a top side, a bottom side, a left side or a right side of the earphone. The plurality of the adjustment sensors may not be arranged next to each other. For example, the earphone may comprise a first adjustment sensor at a first side of the earphone and a second adjustment sensor at a second side of the earphone. The first side and the second side may be arranged opposite to each other. For instance, the first side may be arranged at a top side of the earphone i.e. close to a pinna of the user's ear, when the user is wearing the earphone at its intended position. The second side may be arranged at a bottom side of the earphone i.e. close to a lobule of the user's ear, when the user is wearing the earphone at its intended position. Another example, the first side may be arranged at a right side of the earphone when the user is wearing the earphone at its intended position. The second side may be arranged at a left side of the earphone when the user is wearing the earphone at its intended position. Yet another example, if the adjustment sensor comprises a plurality of f. ex. touch sensors, the plurality of the touch sensors may be arranged on a circumference around the centerline of rotation. Alternatively, the plurality of the touch sensors may be arranged adjacent to center line for translational movement. The plurality of the touch sensors may all be in contact with the user's skin when the user wears the earphone at its intended position. During rotational or translational movement the touch sensors may sense different touches and calculate a movement based on the signals received from the plurality of touch sensors.

The user may provide the adjustment input to the adjustment sensor by applying a force to the earphone at the adjustment sensor. For instance, the user may apply the force to the earphone at the adjustment sensor using one finger. The user may provide the adjustment input to the adjustment sensor by forcing or pressing the earphone upwards, downwards or towards sides to provide the adjustment input. The user may provide the adjustment input to the adjustment sensor by applying a pressure to the earphone at the adjustment sensor. For instance, the user may apply a pressure to the earphone at the adjustment sensor using one finger. The user may provide the adjustment input to the adjustment sensor by rotating the earphone. For instance, the user may hold the earphone by a thumb and an index finger and rotate the earphone clockwise or anti-clockwise. One of the thumb or the index finger may be arranged at the activation sensor.

The adjustment sensor is configured to provide the adjustment signal. The adjustment sensor may be configured to provide the adjustment signal to the processing unit.

The activation sensor may be coupled to the adjustments sensor, such that the adjustment sensor may only provide an adjustment signal, when it receives an activation signal from the activation sensor. The activation sensor may not be coupled to the adjustments sensor.

The activation sensor may be arranged between the adjustment sensor and the processing unit such that the adjustment signal may only pass through to the processing unit when an activation signal is provided.

The processing unit is configured to receive the activation signal and the adjustment signal. The processing unit may be coupled to the activation sensor. The processing unit may be coupled to the adjustment sensor. The processing unit may not be coupled to the activation sensor. The processing unit may not be coupled to the adjustment sensor. For instance, the activation sensor and the adjustment sensor may be coupled to another electronic component e.g. an intermediate component and that intermediate component may be coupled to the processing unit. The processing unit may be configured to determine if the adjustment input is received simultaneously with the activation input i.e. if the adjustment input is received at the same time as receiving the activation input.

The processing unit is configured to execute the command if the adjustment signal is received simultaneously with reception of the activation signal. Thereby, the earphone receives, executes and performs the command from the user wearing the earphone if the adjustment signal is received simultaneously with reception of the activation signal. In other words, the earphone receives, executes and performs the command from the user wearing the earphone when the user provides the adjustment input simultaneously with providing the activation input.

It is an advantage that the earphone comprises two sensors i.e. the activation sensor and the adjustment sensor. Thereby, the earphone comprising the activation sensor and the adjustment sensor provides the user with two interfaces and hence allows for providing more options to the user i.e. allows for receiving more commands from the user. In overall, the earphone provides a simple, flexible, intuitive, easy-to-use and user-friendly interface. In addition, the activation sensor and the adjustment sensor allow the earphone to be compact, as they may conveniently be fitted in the earphone i.e. they do not require extra space such as e.g. a stem.

In an embodiment, a hearing device is configured to be worn by a user. The hearing device may be arranged at the user's ear, on the user's ear, over the user's ear, in the user's ear, in the user's ear canal, behind the user's ear and/or in the user's concha, i.e., the hearing device is configured to be worn in, on, over and/or at the user's ear. The user may wear two hearing devices, one hearing device at each ear. The two hearing devices may be connected, such as wirelessly connected and/or connected by wires, such as a binaural hearing aid system.

The hearing device may be a hearable such as a headset, headphone, earphone, earbud, hearing aid, a personal sound amplification product (PSAP), an over-the-counter (OTC) hearing device, a hearing protection device, a one-size-fits-all hearing device, a custom hearing device or another head-wearable hearing device. Hearing devices can include both prescription devices and non-prescription devices.

The hearing device may be embodied in various housing styles or form factors. Some of these form factors are Receiver-in-Canal (RIC) hearing device, Receiver-in-Ear (RIE) hearing device or Microphone-and-Receiver-in-Ear (MaRIE) hearing device. These devices may comprise a Behind-the-Ear (BTE) unit configured to be worn behind the ear of the user and an in the ear (ITE) unit configured to be inserted partly or fully into the user's ear canal. Generally, the BTE unit may comprise at least one input transducer, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

Some of these form factors are In-the-Ear (ITE) hearing device, Completely-in-Canal (CIC) hearing device or Invisible-in-Canal (IIC) hearing device. These hearing devices may comprise an ITE unit, wherein the ITE unit may comprise at least one input transducer, a power source, a processing unit and an output transducer. These form factors may be custom devices, meaning that the ITE unit may comprise a housing having a shell made from a hard material, such as a hard polymer or metal, or a soft material such as a rubber-like polymer, molded to have an outer shape conforming to the shape of the specific user's ear canal.

Some of these form factors are earbuds, on the ear headphones or over the ear headphones. The person skilled in the art is well aware of different kinds of hearing devices and of different options for arranging the hearing device in, on, over and/or at the ear of the hearing device wearer. The hearing device (or pair of hearing devices) may be custom fitted, standard fitted, open fitted and/or occlusive fitted.

In an embodiment, the hearing device may comprise one or more input transducers. The one or more input transducers may comprise one or more microphones. The one or more input transducers may comprise one or more vibration sensors configured for detecting bone vibration. The one or more input transducer(s) may be configured for converting an acoustic signal into a first electric input signal. The first electric input signal may be an analogue signal. The first electric input signal may be a digital signal. The one or more input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHz, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

The hearing device may be a headset, a hearing aid, a hearable etc. The hearing device may be an in-the-ear (ITE) hearing device, a receiver-in-ear (RIE) hearing device, a receiver-in-canal (RIC) hearing device, a microphone-and-receiver-in-ear (MaRIE) hearing device, a behind-the-ear (BTE) hearing device comprising an ITE unit, or a one-size-fits-all hearing device etc.

The hearing device is configured to be worn by a user. The hearing device may be arranged at the user's ear, on the user's ear, in the user's ear, in the user's ear canal, behind the user's ear etc. The user may wear two hearing devices, one hearing device at each ear. The two hearing devices may be connected, such as wirelessly connected.

The hearing device may be configured for audio communication, e.g. enabling the user to listen to media, such as music or radio, and/or enabling the user to perform phone calls. The hearing device may be configured for performing hearing compensation for the user. The hearing device may be configured for performing noise cancellation etc.

The hearing device may comprise a RIE unit. The RIE unit typically comprises the earpiece such as a housing, a plug connector, and an electrical wire/tube connecting the plug connector and earpiece. The earpiece may comprise an in-the-ear housing, a receiver, such as a receiver configured for being provided in an ear of a user, and an open or closed dome. The dome may support correct placement of the earpiece in the ear of the user. The RIE unit may comprise an input transducer e.g. a microphone or a receiver, an output transducer e.g. a speaker, one or more sensors, and/or other electronics. Some electronic components may be placed in the earpiece, while other electronic components may be placed in the plug connector. The receiver may be with a different strength, i.e. low power, medium power, or high power. The electrical wire/tube provides an electrical connection between electronic components provided in the earpiece of the RIE unit and electronic components provided in the BTE unit. The electrical wire/tube as well as the RIE unit itself may have different lengths.

The hearing device may comprise an output transducer e.g. a speaker or receiver. The output transducer may be a part of a printed circuit board (PCB) of the hearing device. The output transducer may be arranged on a printed circuit board (PCB) of the hearing device. The output transducer may not be a part of the PCB of the hearing device. The output transducer may be configured to be arranged on the PCB of the hearing device. For instance, the output transducer may be configured to be arranged on an allocated position/area on the PCB of the hearing device. The output transducer may be arranged through a hole in the PCB.

The hearing device may comprise a first input transducer, e.g. a microphone, to generate one or more microphone output signals based on a received audio signal. The audio signal may be an analogue signal. The microphone output signal may be a digital signal. Thus, the first input transducer, e.g. microphone, or an analogue-to-digital converter, may convert the analogue audio signal into a digital microphone output signal. All the signals may be sound signals or signals comprising information about sound.

The hearing device may comprise a signal processor. The one or more microphone output signals may be provided to the signal processor for processing the one or more microphone output signals. The signals may be processed such as to compensate for a user's hearing loss or hearing impairment. The signal processor may provide a modified signal. All these components may be comprised in a housing of an ITE unit or a BTE unit. The hearing device may comprise a receiver or output transducer or speaker or loudspeaker. The receiver may be connected to an output of the signal processor. The receiver may output the modified signal into the user's ear. The receiver, or a digital-to-analogue converter, may convert the modified signal, which is a digital signal, from the processor to an analogue signal. The receiver may be comprised in an ITE unit or in an earpiece, e.g. RIE unit or MaRIE unit. The hearing device may comprise more than one microphone, and the ITE unit or BTE unit may comprise at least one microphone and the RIE unit may also comprise at least one microphone.

The hearing device signal processor may comprise elements such as an amplifier, a compressor and/or a noise reduction system etc. The signal processor may be implemented in a signal-processing chip or on the PCB of the hearing device. The hearing device may further have a filter function, such as compensation filter for optimizing the output signal.

The hearing device may comprise one or more antennas for radio frequency communication. The one or more antenna may be configured for operation in ISM frequency band. One of the one or more antennas may be an electric antenna. One or the one or more antennas may be a magnetic induction coil antenna. Magnetic induction, or near-field magnetic induction (NFMI), typically provides communication, including transmission of voice, audio and data, in a range of frequencies between 2 MHz and 15 MHz. At these frequencies the electromagnetic radiation propagates through and around the human head and body without significant losses in the tissue.

The magnetic induction coil may be configured to operate at a frequency below 100 MHz, such as at below 30 MHz, such as below 15 MHz, during use. The magnetic induction coil may be configured to operate at a frequency range between 1 MHz and 100 MHz, such as between 1 MHz and 15 MHz, such as between 1 MHz and 30 MHz, such as between 5 MHz and 30 MHz, such as between 5 MHz and 15 MHz, such as between 10 MHz and 11 MHz, such as between 10.2 MHz and 11 MHz. The frequency may further include a range from 2 MHz to 30 MHz, such as from 2 MHz to 10 MHz, such as from 2 MHz to 10 MHz, such as from 5 MHz to 10 MHz, such as from 5 MHz to 7 MHz.

The electric antenna may be configured for operation at a frequency of at least 400 MHz, such as of at least 800 MHz, such as of at least 1 GHz, such as at a frequency between 1.5 GHz and 6 GHz, such as at a frequency between 1.5 GHz and 3 GHz such as at a frequency of 2.4 GHz. The antenna may be optimized for operation at a frequency of between 400 MHz and 6 GHz, such as between 400 MHz and 1 GHz, between 800 MHz and 1 GHz, between 800 MHz and 6 GHz, between 800 MHz and 3 GHz, etc. Thus, the electric antenna may be configured for operation in ISM frequency band. The electric antenna may be any antenna capable of operating at these frequencies, and the electric antenna may be a resonant antenna, such as monopole antenna, such as a dipole antenna, etc. The resonant antenna may have a length of λ/4±10% or any multiple thereof, A being the wavelength corresponding to the emitted electromagnetic field.

The hearing device may comprise one or more wireless communications unit(s) or radios. The one or more wireless communications unit(s) are configured for wireless data communication, and in this respect interconnected with the one or more antennas for emission and reception of an electromagnetic field. Each of the one or more wireless communication unit may comprise a transmitter, a receiver, a transmitter-receiver pair, such as a transceiver, and/or a radio unit. The one or more wireless communication units may be configured for communication using any protocol as known for a person skilled in the art, including Bluetooth, WLAN standards, manufacture specific protocols, such as tailored proximity antenna protocols, such as proprietary protocols, such as low-power wireless communication protocols, RF communication protocols, magnetic induction protocols, etc. The one or more wireless communication units may be configured for communication using same communication protocols, or same type of communication protocols, or the one or more wireless communication units may be configured for communication using different communication protocols.

The wireless communication unit may connect to the hearing device signal processor and the antenna, for communicating with one or more external devices, such as one or more external electronic devices, including at least one smart phone, at least one tablet, at least one hearing accessory device, including at least one spouse microphone, remote control, audio testing device, etc., or, in some embodiments, with another hearing device, such as another hearing device located at another ear, typically in a binaural hearing device system.

The hearing device may be a binaural hearing device. The hearing device may be a first hearing device and/or a second hearing device of a binaural hearing device.

The hearing device may be a device configured for communication with one or more other device, such as configured for communication with another hearing device or with an accessory device or with a peripheral device.

In some embodiments, the adjustment input is a rotation. Thereby, the user may provide the adjustment input by rotating the earphone housing in a simple, intuitive, and user-friendly manner.

In some embodiments, the adjustment input is a displacement. Thereby, the user may provide the adjustment input by displacing the earphone housing in a simple, intuitive, and user-friendly manner.

In some embodiments, the earphone further comprises an output controller. The output controller may be configured to provide an output to the user upon receiving the activation input from the user. Thereby, the output, provided by the output controller, may notify the user that the activation input is received. Hence, the user may next provide the adjustment input to the earphone. Alternatively, not receiving any output may notify the user that the activation input is not received. Hence, the user may provide a new activation input to the activation sensor of the earphone. The output may be a voice message or a sound such as a click sound or a beep sound. The output may be provided in the ear of the user when the user is wearing the earphone at its intended position. The output may be provided in the same ear that the user is wearing the earphone at its intended position. Alternatively or in combination, the output may be provided in another ear of the user that the user is wearing another earphone at its intended position. The output may be a text message or a voice message. The output may be provided to an external device connected to the earphone. The external device may be connected via a wire to the earphone. The external device may be wirelessly connected to the earphone. For example, the output may be a text message shown on a cellphone of the user. Another example, the output may be a voice message or a text message shown on a laptop of the user. The output controller may be configured to provide an output to the user upon receiving the adjustment input from the user. The output provided to the user upon receiving the adjustment input from the user may be provided in the same manner as defined above in relation to the output provided to the user upon receiving the activation input from the user.

In some embodiments, the activation sensor, the output controller, the adjustment sensor and the processing unit are arranged at the housing. Thereby, the housing may enclose the activation sensor, the output controller, the adjustment sensor and the processing unit. Thereby, the housing may protect the activation sensor, the output controller, the adjustment sensor and the processing unit against e.g. humidity, dirt, etc. This may in turn increase a life time of the earphone. In addition, the housing may allow for a more compact earphone, as the activation sensor, the output controller, the adjustment sensor and the processing unit may be fitted in the housing in a more compact manner. The activation sensor, the output controller, the adjustment sensor and the processing unit may be arranged inside the housing of the earphone. At least a portion or a part of the activation sensor, the output controller, the adjustment sensor and/or the processing unit may be arranged outside the housing of the earphone. For instance, a portion or a part of the activation sensor, the output controller, the adjustment sensor and/or the processing unit may be arranged at an outer surface of the housing. Thereby, the activation sensor, the output controller, the adjustment sensor and the processing unit may be arranged inside or outside of the housing in a flexible manner.

In some embodiments, the activation sensor is arranged at an inside surface and/or an outside surface of the housing. The housing may have at least one outer surface. The housing may correspondingly have at least one inner surface. The at least one inner surface may be arranged opposite to the at least one outer surface i.e. on an opposite side of the at least one outer surface. The at least one outer surface may face user's surrounding when the user is wearing the earphone in its intended position. The activation sensor may be arranged at the at least one inner surface of the housing. A portion or a part of the activation sensor may be arranged at the at least one outer surface of the housing such that the user may provide the activation input to a portion of the at least one outer surface of the housing. For instance, the user may apply a force to a portion of the at least one outer surface of the housing to provide the activation input. This may in turn apply a force to a portion of the at least one inner surface of the housing and may hence activate the activation sensor.

In some embodiments, the earphone further comprises a transceiver and an antenna and is configured to be wirelessly connected to one or more external devices and/or to another earphone. Thereby, the earphone may be wirelessly connected to one or more external devices and/or to another earphone. This may for instance facilitate providing the output from the output controller of the earphone to the user, upon receiving the activation input from the user. Alternatively or in combination, the earphone may be connected to one or more external devices and/or to another earphone via a wire. The transceiver and the antenna may be arranged at the housing. The transceiver and the antenna may be arranged at the inside surface and/or the outside surface of the housing. The transceiver and the antenna may preferably be arranged at the inside surface of the housing.

In some embodiments, the earphone further comprises a surface feature for facilitating the activation input and/or the adjustment input provided by the user. Thereby, the surface feature may also facilitate providing a more user-friendly earphone. The surface feature may comprise any of or any combination of a button, a small handle, a small protrusion, a surface roughness, ribs, corrugations or an indentation.

In some embodiments, the surface feature is arranged at the activation sensor and/or the adjustment sensor. Hence, the user may conveniently identify where the activation sensor and/or the adjustment sensor are arranged. In addition, the user may conveniently grab the surface feature to provide the activation input and/or the adjustment input.

In some embodiments, the command comprises any of or any combination of volume control, toggle switch, play/pause media content or activation or deactivation of a functionality of the earphone. An example of the activation of the functionality of the earphone may comprise activation of active noise cancellation (ANC). An example of the deactivation of the functionality of the earphone may correspondingly comprise deactivation of active noise cancellation (ANC). Another example of the activation of the functionality of the earphone may comprise activation of a hear-through mode. Yet another example of the activation of the functionality of the earphone may comprise answering a call or ending a call. An example of toggle switch may comprise jumping to a next song or a previous song.

In some embodiments, the earphone further comprises a stem for facilitating the activation input and/or the adjustment input provided by the user. For instance, the stem may facilitate forcing or pressing the earphone upwards, downwards or towards sides to provide the activation input and/or the adjustment input. The activation sensor and/or the adjustment sensor may be arranged at the stem. Thereby, the stem may provide more space for arranging the activation sensor and/or the adjustment sensor. The stem may be the surface feature.

According to a second aspect, disclosed is a method of performing a command by an earphone. The method comprises the step of receiving an activation input from a user wearing the earphone. The method further comprises the step of providing an output to the user, upon receiving the activation input. The method further comprises the step of receiving an adjustment input from the user. The method further comprises the step of performing a command if the adjustment input is received simultaneously with reception of the activation input. Thereby, the method performs the command, provided by the user, by providing a simple, flexible, intuitive, easy-to-use and user-friendly interface. This aspect may generally present the same or corresponding advantages as the first aspect.

In some embodiments, the step of receiving the activation input comprises receiving a force applied by the user at the activation sensor of the earphone. This may facilitate the step of receiving the activation input, as the user may apply a force to the earphone at the activation sensor using e.g. one finger. In addition, this may provide an even more improved interface e.g. simpler, more flexible, more intuitive, more easy-to-use and more user-friendly interface.

In some embodiments, the step of receiving the adjustment input comprises receiving a rotation of the earphone by the user. This may facilitate the step of receiving the adjustment input, as the user may hold the earphone by e.g. two fingers and rotate the earphone clockwise or anti-clockwise. For instance, the user may hold the earphone by a thumb and an index finger and rotate the earphone clockwise or anti-clockwise. In addition, this may provide an even more improved interface e.g. simpler, more flexible, more intuitive, more easy-to-use and more user-friendly interface.

In some embodiments, the step of receiving the adjustment input comprises receiving a displacement of the earphone by the user. This may facilitate the step of receiving the adjustment input, as the user may displace the earphone using e.g. one finger. In addition, this may provide an even more improved interface e.g. simpler, more flexible, more intuitive, more easy-to-use and more user-friendly interface.

In some embodiments, the step of receiving the adjustment input comprises receiving a force or pressure applied by the user at the adjustment sensor of the earphone. This may facilitate the step of receiving the adjustment input, as the user may apply a force or a pressure to the earphone at the adjustment sensor using e.g. one finger. In addition, this may provide an even more improved interface e.g. simpler, more flexible, more intuitive, more easy-to-use and more user-friendly interface.

In some embodiments, the method further comprises continually receiving the activation input from the user while receiving the adjustment input from the user such that the adjustment input is received simultaneously with receiving of the activation input.

The present invention relates to different aspects including the earphone and the method of performing a command by the earphone described above and in the following, and corresponding device parts, each yielding one or more of the benefits and advantages described in connection with the first mentioned aspect, and each having one or more embodiments corresponding to the embodiments described in connection with the first mentioned aspect and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates a perspective view of an exemplary earphone 100.

FIG. 2 schematically illustrates a cross-sectional side view of the exemplary earphone 100, shown in FIG. 1.

FIG. 3 schematically illustrates a perspective view of another exemplary earphone 100.

FIG. 4 schematically illustrates a perspective view of yet another exemplary earphone 200.

FIG. 5 schematically illustrates steps of a method 300 of performing a command by an earphone 100, 200.

FIG. 6 schematically illustrates an exemplary illustration of a user wearing an earphone 100 while performing the method 300, shown in FIG. 5.

FIGS. 7a-c schematically illustrate three different ways of coupling an activation sensor, an adjustment sensor and a processing unit of an earphone.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

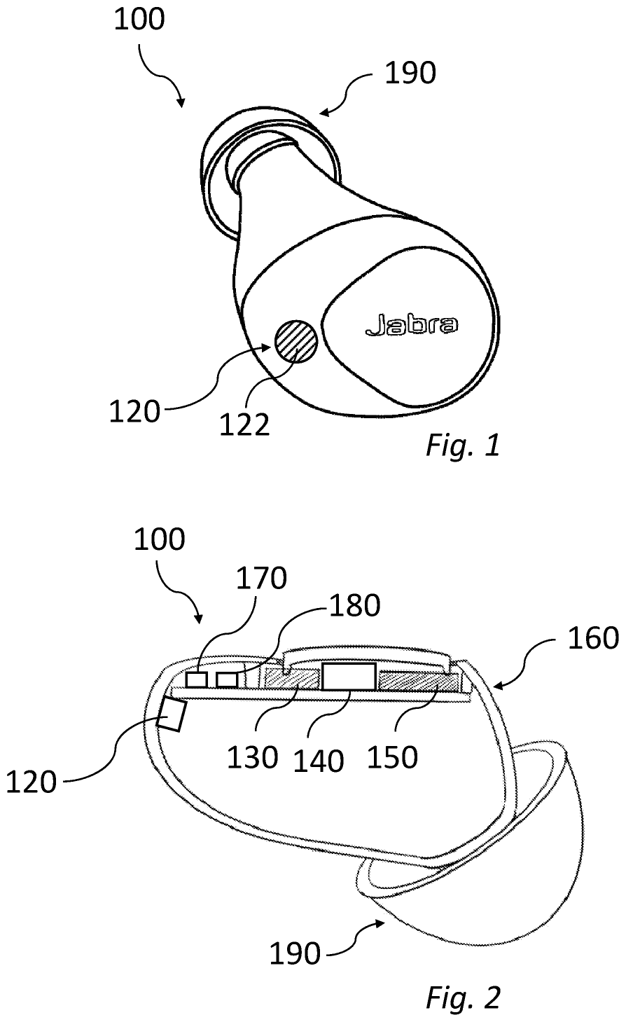

FIG. 1 illustrates a perspective view of an exemplary earphone 100. The earphone 100, shown in FIG. 1, is in the form of an earbud. The earphone 100 comprises an activation sensor 120. The activation sensor 120 is configured to receive an activation input from a user 10 and provide an activation signal. The earphone 100 further comprises an adjustment sensor 140. The adjustment sensor 140 is configured to receive an adjustment input from the user 10 and provide an adjustment signal. The earphone 100 further comprises a processing unit 150. The processing unit 150 is configured to receive the activation signal and the adjustment signal and execute a command if the adjustment signal is received simultaneously with reception of the activation signal. FIG. 1 further shows that the earphone 100 comprises a dome 190. The dome 190 may support correct placement of the earphone in the ear of the user. The earphone 100 may further comprise an output controller 130. The output controller 130 may be configured to provide an output to the user 10 upon receiving 340 the activation input from the user 10. The earphone 100 may further comprise a housing 160. The activation sensor 120, the output controller 130, the adjustment sensor 140 and the processing unit 150 may be arranged at the housing 160. The earphone 100 may further comprises a transceiver 170 and an antenna 180 to be wirelessly connected to one or more external devices and/or to another earphone 100. FIG. 1 shows that the activation sensor 120 comprises a button. FIG. 1 further shows that the earphone 100 further comprises a surface feature 122. FIG. 1 shows that the surface feature 122 is arranged at the activation sensor 120. The surface feature 122 may facilitate the activation input and/or the adjustment input provided by the user 10. The surface feature 122 may be arranged at the activation sensor 120 and/or adjustment sensor 140.

FIG. 2 schematically illustrates a cross-sectional side view of the exemplary earphone 100, shown in FIG. 1. FIG. 2 shows that the activation sensor 120, the output controller 130, the adjustment sensor 140, the processing unit 150, the transceiver 170 and the antenna 180 are arranged at the housing 160 and inside the housing 160.

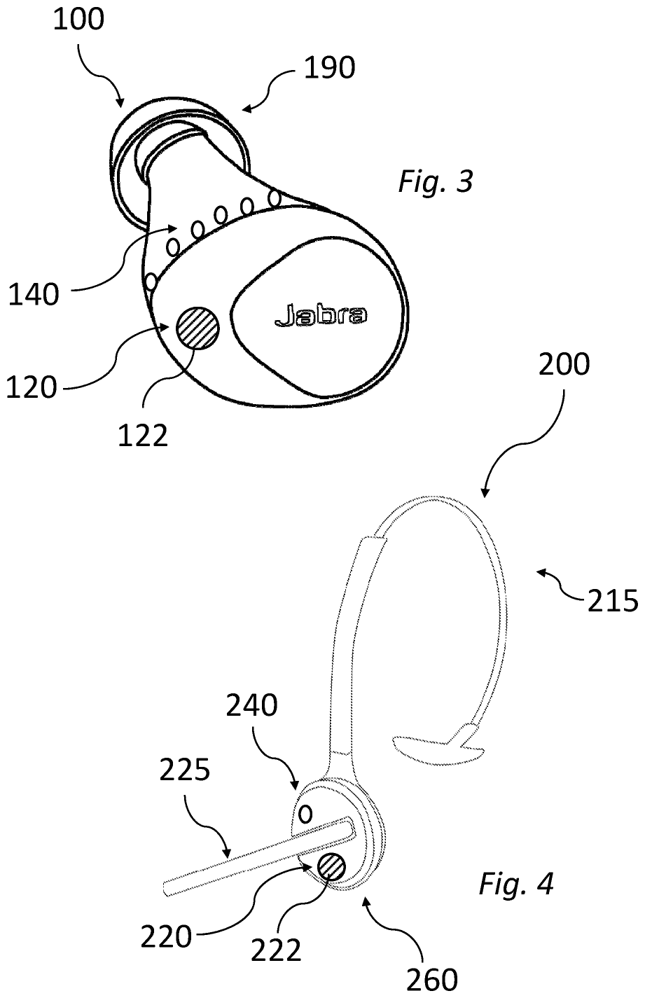

FIG. 3 schematically illustrates a perspective view of another exemplary earphone 100. The earphone 100, shown in FIG. 3, is in the form of an earbud. The earphone 100, shown in FIG. 3, comprises a plurality of adjustment sensors 140. FIG. 3 shows that the earphone 100 comprises six adjustment sensors 140. FIG. 3 shows that the plurality of the adjustment sensors 140 are arranged next to each other. The plurality of the adjustment sensors 140 may not be arranged next to each other.

FIG. 4 schematically illustrates a perspective view of yet another exemplary earphone 200. The earphone 200, shown in FIG. 4, is in the form of a headphone. The earphone 200 comprises an activation sensor 220. The activation sensor 220 is configured to receive an activation input from a user 10 and provide an activation signal. The earphone 200 further comprises an adjustment sensor 240. The adjustment sensor 240 is configured to receive an adjustment input from the user 10 and provide an adjustment signal. The earphone 200 further comprises a processing unit 250. The processing unit 250 is configured to receive the activation signal and the adjustment signal and execute a command if the adjustment signal is received simultaneously with reception of the activation signal. The earphone 200 may further comprise an output controller 230. The output controller 230 may be configured to provide an output to the user 10 upon receiving 340 the activation input from the user 10. FIG. 4 shows that the earphone 200 comprises a housing 260. The activation sensor 220, the output controller 230, the adjustment sensor 240 and the processing unit 250 may be arranged at the housing 260. The earphone 200 may further comprises a transceiver 270 and an antenna 280 to be wirelessly connected to one or more external devices and/or to another earphone 200. FIG. 4 shows that the earphone 200 comprises a headband 215 and a microphone boom 225.

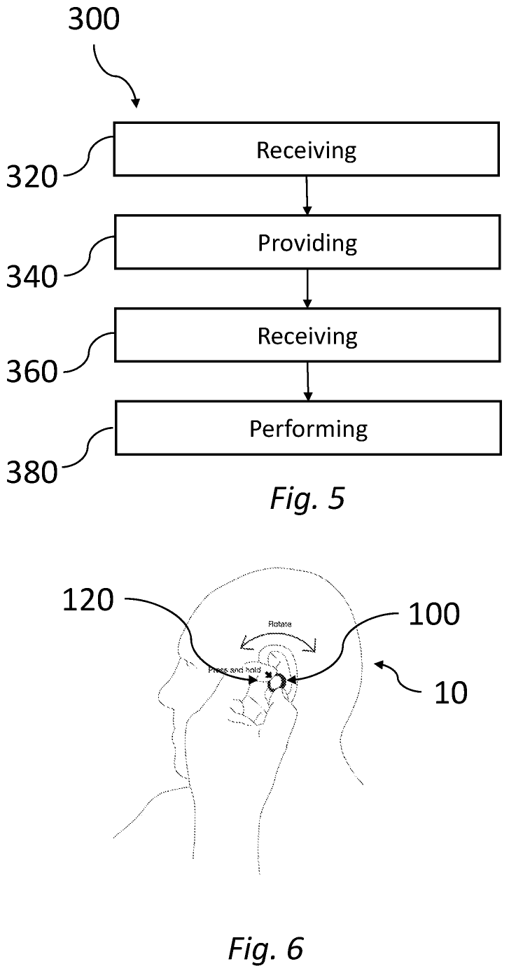

FIG. 5 schematically illustrates steps of a method 300 of performing a command by an earphone 100, 200. The method 300 comprises the step of receiving 320 an activation input from a user 10 wearing the earphone 100, 200. The step of receiving 320 the activation input may comprise receiving a force applied by the user 10 at the activation sensor 120, 220 of the earphone 100, 200. The method 300 further comprises providing 340 an output to the user 10, upon receiving 320 the activation input. The method 300 further comprises receiving 360 an adjustment input from the user 10. The step of receiving 360 the adjustment input may comprise receiving a rotation of the earphone 100, 200 by the user 10. The step of receiving 360 the adjustment input may comprise receiving a force applied by the user 10 at the adjustment sensor 140, 240 of the earphone 100, 200. The step of receiving 360 the adjustment input may comprise receiving a pressure applied by the user 10 at the adjustment sensor 140, 240 of the earphone 100, 200. The method 300 further comprises performing the command 380 if the adjustment input is received simultaneously with reception of the activation input.

FIG. 6 schematically illustrates an exemplary illustration of a user 10 wearing an earphone 100 while performing the method 300, shown in FIG. 5. The earphone 100, shown in FIG. 6, may be the same as the earphone 100 shown in FIG. 1. FIG. 6 shows that the user 10 holds and presses the earphone at the activation sensor 120. FIG. 6 further shows that the user 10 rotates the earphone 100 while pressing the earphone 100 at the activation sensor 120 to provide a command. The earphone 100, shown in FIG. 6, performs the command, provided by the user 10, according to the method 300 shown in FIG. 5. It should be understood, that the rotation may be very small and that the earphone 100, 200 may rotate back to the normal position when the user releases the earphone 100, 200.

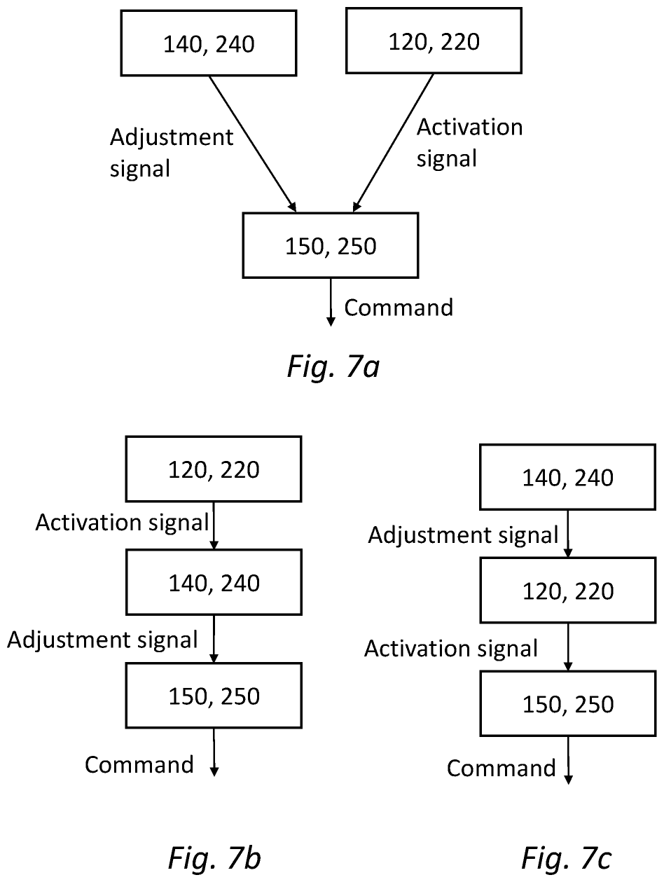

FIGS. 7a-c show three different ways of coupling the activation sensor 120, 220, the adjustment sensor 140, 240 and the processing unit 150, 250 of an earphone 120, 220. In FIG. 7a the processing unit 150, 250 executes a command, such as adjusting the volume when it receives the adjustment signal and the activation signal simultaneously. In FIG. 7b the activation sensor “activates” the adjustments sensor 140, 240, whereby the processing unit 150, 250 does not receive an adjustment signal from the adjustment sensor 140, 240 unless the adjustment sensor 140, 240 receives an activation signal from the activation sensor 120, 220. In FIG. 7c the activation sensor 120, 220 is coupled between the adjustment sensor 140, 240 and the processing unit 150, 250 and the activation sensor 120, 220 only lets the adjustment signal pass-through to the processing unit 150, 250, when the activation sensor 120, 220 provides an activation signal.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### Items:

1. An earphone (100, 200) comprising:
an earphone housing (160, 260),
an activation sensor (120, 220) configured to sense an activation input from a user (10) and provide an activation signal,
   an adjustment sensor (140, 240) configured to sense an adjustment input from the user (10) and provide an adjustment signal, wherein the adjustment input is a movement of the earphone housing (160, 260) and
   a processing unit (150, 250) configured to receive the adjustment signal and execute a command if the adjustment signal is received simultaneously with provision of the activation signal.
      2. The earphone (100, 200) according to item 1, wherein the adjustment input is a rotation.
      3. An earphone (100 200) according to item 1, wherein the adjustment input is a displacement.
      4. The earphone (100, 200) according to any of the preceding items, wherein the earphone (100, 200) further comprises an output controller (130, 230) and wherein the output controller (130, 230) is configured to provide an output to the user (10) upon receiving (340) the activation input from the user (10).
      5. The earphone (100, 200) according to item 4, wherein the activation sensor (120, 220), the output controller (130, 230), the adjustment sensor (140, 240) and the processing unit (150, 250) are arranged at the housing (160, 260).
      6. The earphone (100, 200) according to item 5, wherein the activation sensor (120, 220) is arranged at an inside surface and/or an outside surface of the housing (160, 260).
      7. The earphone (100, 200) according to any of the preceding items, wherein the earphone (100, 200) further comprises a transceiver (170, 270) and an antenna (180, 280) and is configured to be wirelessly connected to one or more external devices and/or to another earphone (100, 200).
      8. The earphone (100, 200) according to any of the preceding items, wherein the earphone (100, 200) further comprises a surface feature (122, 222) for facilitating the activation input and/or the adjustment input provided by the user (10).
      9. The earphone (100, 200) according to item 8, wherein the surface feature (122, 222) is arranged at the activation sensor (120, 220) and/or the adjustment sensor (140, 240).
      10. The earphone (100, 200) according to any of the preceding items, wherein the command comprises any of or any combination of:
volume control;
toggle switch;
play/pause media content; or
activation or deactivation of a functionality of the earphone (100, 200).
   11. The earphone (100, 200) according to any of the preceding items, wherein the earphone (100, 200) further comprises a stem for facilitating the activation input and/or the adjustment input provided by the user.
   12. A method (300) of performing a command by an earphone (100, 200), the method (300) comprising the steps of:
receiving (320) an activation input from a user (10) wearing the earphone (100, 200),
providing (340) an output to the user (10), upon receiving (320) the activation input,
   receiving (360) an adjustment input from the user (10), and
   performing a command (380) if the adjustment input is received simultaneously with reception of the activation input.
      13. The method (300) according to item 12, wherein the step of receiving (320) the activation input comprises receiving a force applied by the user (10) at the activation sensor (120, 220) of the earphone (100, 200).
      14. The method (300) according to item 12 or 13, wherein the step of receiving (360) the adjustment input comprises receiving a rotation of the earphone (100, 200) by the user (10).
      15. The method (300) according to item 12 or 13, wherein the step of receiving (360) the adjustment input comprises receiving a displacement of the earphone (100, 200) by the user (10).
      16. The method (300) according to item 12 or 13, wherein the step of receiving (360) the adjustment input comprises receiving a force or a pressure applied by the user (10) at the adjustment sensor (140, 240) of the earphone (100, 200).

### LIST OF REFERENCES

10 User
100, 200 Earphone
120, 220 Activation sensor
122, 222 Surface feature
130, 230 Output controller
140, 240 Adjustment sensor
150, 250 Processing unit
160, 260 Housing
170, 270 Transceiver
180, 280 Antenna
190 Dome
215 Headband
225 Microphone boom
300 Method
320 Method step of receiving
340 Method step of providing
360 Method step of receiving
380 Method step of performing

1. An earphone comprising:
an earphone housing,
an activation sensor configured to sense an activation input from a user and provide an activation signal,
an adjustment sensor configured to sense an adjustment input from the user and provide an adjustment signal, wherein the adjustment input is a movement of the earphone housing
a processing unit configured to receive the adjustment signal and execute a command if the adjustment signal is received simultaneously with provision of the activation signal;
wherein the activation sensor is a force sensor, and wherein the activation signal may only be present while a user applies a force to the earphone at the activation sensor.

2. The earphone according to claim 1, wherein the adjustment input is a rotation.

3. An earphone according to claim 1, wherein the adjustment input is a displacement.

4. The earphone according to claim 1, wherein the earphone further comprises an output controller and wherein the output controller is configured to provide an output to the user upon receiving the activation input from the user.

5. The earphone according to claim 4, wherein the activation sensor, the output controller, the adjustment sensor and the processing unit are arranged at the housing.

6. The earphone according to claim 5, wherein the activation sensor is arranged at an inside surface and/or an outside surface of the housing.

7. The earphone according to claim 1, wherein the earphone further comprises a transceiver and an antenna and is configured to be wirelessly connected to one or more external devices and/or to another earphone.

8. The earphone according to claim 1, wherein the earphone further comprises a surface feature for facilitating the activation input and/or the adjustment input provided by the user.

9. The earphone according to claim 8, wherein the surface feature is arranged at the activation sensor and/or the adjustment sensor.

10. The earphone according to claim 1, wherein the command comprises any of or any combination of:
volume control;
toggle switch;
play/pause media content; or
activation or deactivation of a functionality of the earphone.

11. The earphone according to claim 1, wherein the earphone further comprises a stem for facilitating the activation input and/or the adjustment input provided by the user.

12. A method of performing a command by an earphone, the method a comprising the steps of:
receiving an activation input from a user wearing the earphone,
providing an output to the user, upon receiving the activation input,
receiving an adjustment input from the user, and
performing a command if the adjustment input is received simultaneously with reception of the activation input, and
wherein the activation input may only be present while a user applies a force to the earphone at the activation input.

13. The method according to claim 12, wherein the step of receiving the activation input comprises receiving a force applied by the user at the activation sensor of the earphone.

14. The method according to claim 12, wherein the step of receiving the adjustment input comprises receiving a rotation of the earphone by the user.

15. The method according to claim 12, wherein the step of receiving the adjustment input comprises receiving a displacement of the earphone by the user.
